(19) United States
(12) Patent Application Publication
(10) Pub. No.: US 2015/0177667 A1
(43) Pub. Date: Jun. 25, 2015

(54) RAISED SUPPORT IMAGE CORRESPONDING TO TYPE OF MEDIA TO SUPPORT MEDIA

(71) Applicants: Eyal Peleg, Zoran (IL); Shahar Stein, Petach-Tikva (IL); Wael Salalha, Bet Jan galil (IL); Doron Avramov, gedera (IL)

(72) Inventors: Eyal Peleg, Zoran (IL); Shahar Stein, Petach-Tikva (IL); Wael Salalha, Bet Jan galil (IL); Doron Avramov, gedera (IL)

(73) Assignee: HEWLETT-PACKARD INDIGO B.V., Fort Collins, CO (US)

(21) Appl. No.: 14/407,015

(22) PCT Filed: Jun. 27, 2012
(86) PCT No.: PCT/EP2012/062442

§ 371 Date: Dec. 10, 2014

(51) Int. Cl. G03G 15/00

(52) U.S. Cl. CPC G03G 15/6529

(57) ABSTRACT

An image forming apparatus includes a determination unit, a print unit, and an image forming blanket. The determination unit may determine a raised support image having a support perimeter to be printed on an impression media corresponding to a type of media. The print unit may at least one of print the image to be transferred by the image forming blanket to the media and print the raised support image determined by the determination unit on the impression media. The support perimeter may be smaller than the media perimeter. The image forming blanket may transfer the image to a front surface of the media from the image forming blanket by contacting the media and bending the edge portion of the media about the raised support image.

### BACKGROUND

Image forming apparatuses may include a print unit and an image forming blanket to transfer an image to media. The print unit may apply ink to a PIP to form an image thereon. The PIP may transfer the image to an image forming blanket. Subsequently, the image forming blanket may transfer the image to the media.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating an image forming apparatus according to an example.

FIG. 2 is a perspective view illustrating media, an impression media, and a raised support image according to an example.

FIG. 3A is a side view illustrating a media, an impression media, and a raised support image in cooperation with each other in an image non-transfer state according to an example.

FIG. 3B is a side view illustrating media, an impression media, a raised support image, and an image forming blanket in cooperation with each other in an image transfer state according to an example.

FIG. 3C is a side view illustrating media, an impression media, a raised support image, and an image forming blanket in cooperation with each other in an image transfer state according to an example.

FIG. 3D is a side view illustrating an edge profile of the raised support image of FIG. 3C according to an example.

FIGS. 4A, 4B and 4C are cross-sectional views taken along line A-A of FIG. 2 according to examples.

FIG. 4D is a perspective view illustrating a raised support image and an impression media according to an example.

FIG. 5 is a schematic view of the image forming apparatus of FIG. 1 according to an example.

FIG. 6 is a flowchart illustrating a method of transferring an image from an image forming blanket to media according to an example.

FIG. 7 is a block diagram illustrating a computing device such as an image forming apparatus including a processor and a non-transitory, computer-readable storage medium to store instructions to operate the computing device to transferring an image from an image forming blanket to media according to an example.

### DETAILED DESCRIPTION

Image forming apparatuses may include a print unit, a photo-imaging cylinder (PIP), and an image forming blanket to transfer an image to media. The print unit may apply ink to the PIP to form an image thereon. For example, the PIP may form an electrostatic image thereon to attract the ink provided by the print unit to form the image thereon. The PIP may transfer the image to an image forming blanket. Subsequently, the image forming blanket may transfer the image to the media. For example, in an image transfer state, the image forming blanket may contact a front surface of the media to transfer the image thereon while a back surface of the media is in contact with an impression media. Alternatively, in an image non-transfer state, the image forming blanket may not contact a front surface of the media and not transfer the image thereon. In some examples, the image forming blanket 13 is resilient.

The image forming blanket may extend beyond the edges of the media. Further, the contacting portion and the non-contacting portion of the image forming blanket may be compressed uniformly and not be subjected to stretching forces. The transition portion of the image forming blanket corresponding to the edge of the media that transitions from contact with the media to non-contact with the media, however, may be compressed non-uniformly. Thus, the transition portions of the image forming blanket may be subjected to stressing forces. The continual cycle of the application of stretching forces during the image transfer state and non-application of stretching forces during the image non-transfer state to the transition portion of the image forming blanket may result in edge marks thereon and/or degradation of the image forming blanket. Consequently, such edge marks may reproduce themselves from the image forming blanket to subsequent media and the degradation to the image forming blanket may reduce its lifespan.

In examples, an image forming apparatus includes, amongst other things, a determination unit, a print unit, and an image forming blanket. The determination unit may determine a type of a raised support image having a support perimeter to be printed on an impression media corresponding to a type of media. The print unit may at least one of print the image to be transferred by the image forming blanket to the media and print the type of the raised support image determined by the determination unit on the impression media such that the support perimeter is smaller than the media perimeter. The image forming blanket may transfer the image to a front surface of the media from the image forming blanket by contacting the media and bending the edge portion of the media about the raised support image. Accordingly, the edge portion of the media may create a curved and/or rounded shape for the transition portion of the image forming blanket to conform to in the image transfer state reducing stressing forces thereon. Further, an ability of debris and fibers from the edge of the media to penetrate the image forming blanket may be reduced. Consequently, the formation of edge marks on the image forming blanket and degradation of the image forming blanket may be reduced.

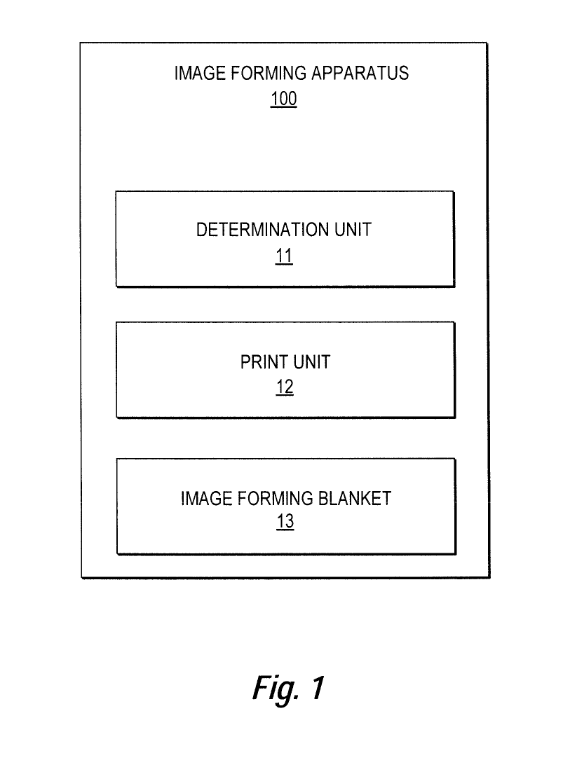

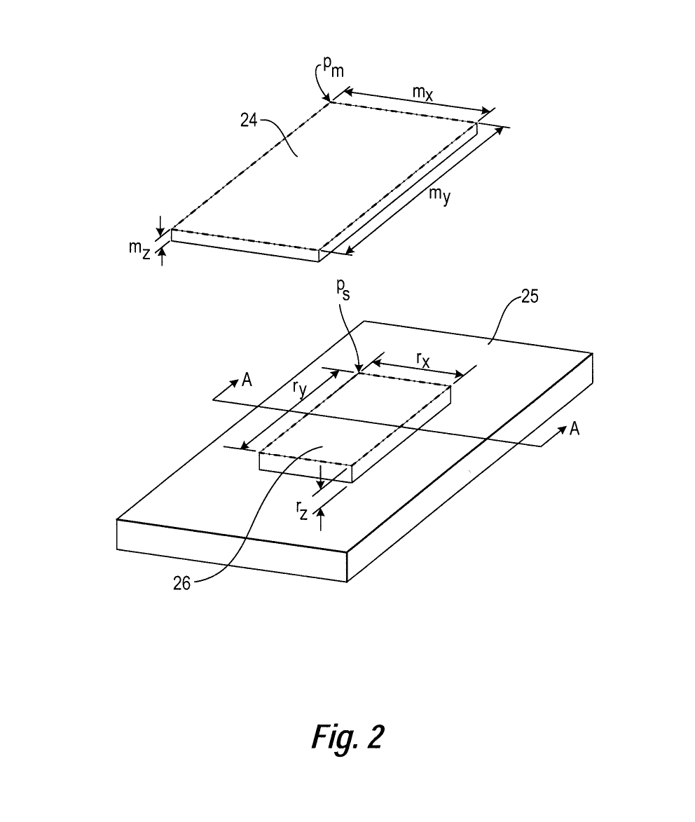

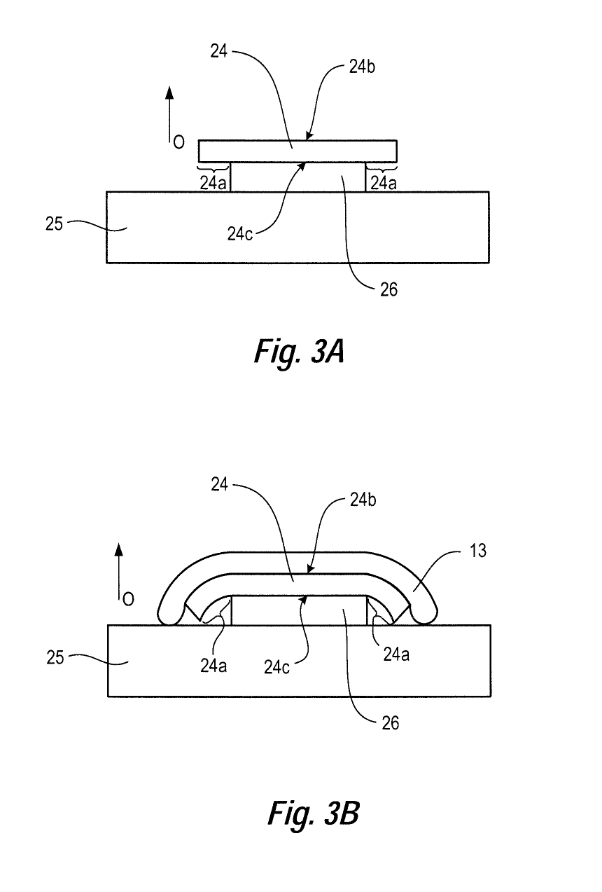

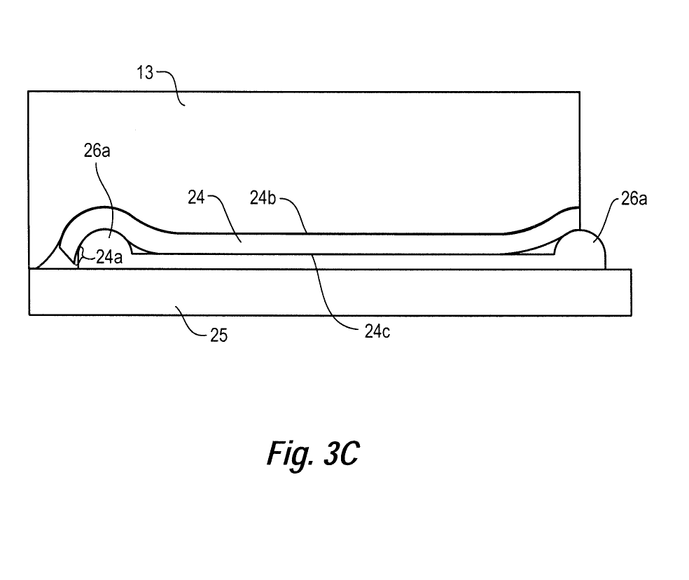

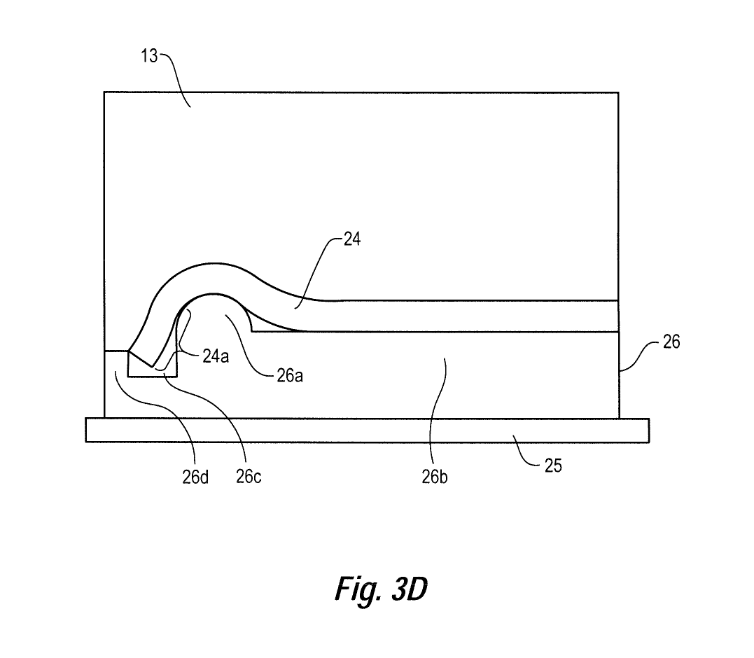

FIG. 1 is a block diagram illustrating an image forming apparatus according to an example. FIG. 2 is a perspective view illustrating media, an impression media, and a raised support image according to an example. FIG. 3A is a side view illustrating media, an impression media, and a raised support image in cooperation with each other in an image non-transfer state according to an example. FIG. 3B is a side view illustrating media, an impression media, a raised support image, and an image forming blanket in cooperation with each other in an image transfer state according to an example. FIG. 3C is a side view illustrating media, an impression media, a raised support image, and an image forming blanket in cooperation with each other in an image transfer state according to an example. Referring to FIGS. 1-3C, in some examples, an image forming apparatus 100 includes a determination unit 11, a print unit 12, and an image forming blanket 13. The image forming apparatus 100 may include a liquid electro photographic (LEP) apparatus, a xerography apparatus, and an inkjet printer. The term LEP may refer to a process of printing in which a liquid toner is applied through an electric field onto a surface forming an electrostatic pattern to form an image. In most LEP processes, the respective image is subsequently transferred to at least one intermediate surface such as an image forming blanket 13, and ultimately to the media 24.

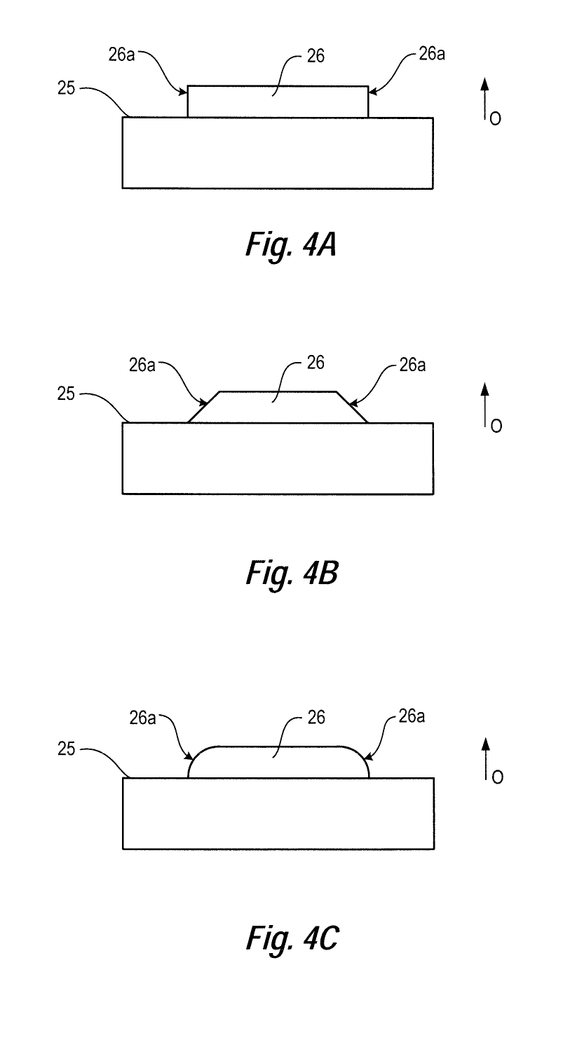

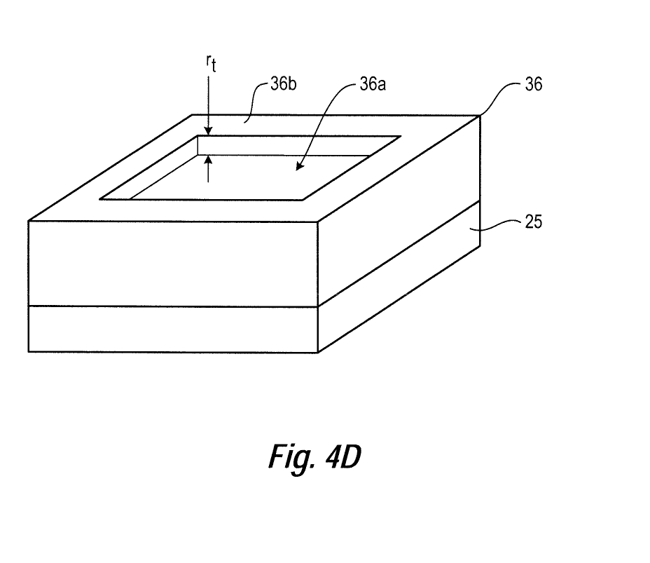

In some examples, the determination unit 11 may determine a type of raised support image 26 having a support perimeter pₛ to be printed on an impression media 25 corresponding to a type of media 24 having a media perimeter pₘ. The determination unit 11 may determine the type of raised support image 26 by at least one of a shape, a size and a thickness of the raised support image 26. For example, the size of the raised support image 26 may include a raised support image width rₓ, a raised support image length r_{y}, and/or a raised support image thickness r_{z}. Additionally, the raised support image 26 may be formed by a multilayer image having an edge profile 26a extending in an outward direction from the impression media 25. For example, ink layers may be accumulated on the impression media 25. In some examples, the edge profile 26a may include at least one of a vertical edge substantially perpendicular to the impression media 25 (FIG. 4A), a slanted edge (FIG. 4B), and a rounded edge (FIG. 4C). The raised support image 26 may be in a form of a variety of shapes including an irregular shape.

Alternatively, the raised support image 26 may have an edge profile including rounded bumps 26a and a central section 26b disposed between the rounded bumps 26a as illustrated in FIG. 3C. The rounded bumps 26a may allow the media 24 to create a curved and/or rounded shape for a transition portion of the image forming blanket 13 to conform in the image transfer state and, thus, reducing stressing forces on the image forming blanket 13. The central section 26b may be flat and have a uniform thickness. Additionally, an edge portion 24a of the media may be positioned on top of or extend beyond the rounded bump 26a. Alternatively, the edge profile of the raised support image 26 may include a position member 26d, a rounded bump 26a, and an end recess 26c disposed between the stop member 26d and the end recess 26c as illustrated in FIG. 3D. Referring to FIG. 3D, the rounded bump 26a may allow the edge portion 24a of the media 24 to create a curved and/or rounded shape for a transition portion of the image forming blanket 13 to conform in the image transfer state. The end recess 26c may provide space for the edge portion 24a of the media to reside. The stop member 26d may support a portion of the edge portion to position the edge portion 24a in the end recess 26c. In some examples, the type of media 24 may include at least one of a size, a thickness m_{z}, and a shape of the media 24. For example, the type of the media may correspond to the media's size such as a media width mₓ and a media height m_{y}.

In some examples, the determination unit 11 may be implemented in hardware, software including firmware, or combinations thereof. The firmware, for example, may be stored in memory and executed by a suitable instruction-execution system. If implemented in hardware, as in an alternative example, the determination unit 11 may be implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In other examples, the determination unit 11 may be implemented in a combination of software and data executed and stored under the control of a computing device. For example, in some examples, the determination unit 11 may use a lookup table derived from empirical data, a recursive process of measuring deflection and adjusting the raised support image 26, and/or physical properties of the media such as elastic modulus of the media, dimensions and shape of the media, image forming blanket stiffness, the applied forces, and/or image forming blanket structure, and the like.

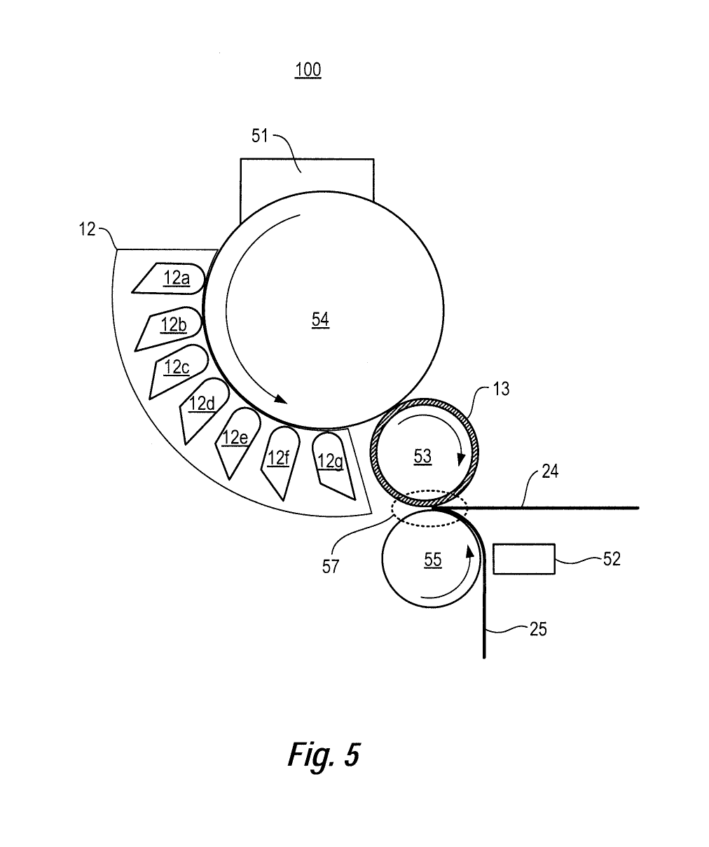

Referring to FIGS. 1-3C, in some examples, the print unit 12 may at least one of print the image to be transferred by the image forming blanket 13 onto the media 24 and print the raised support image 26 determined by the determination unit 11 on the impression media 25 such that the support perimeter pₛ is smaller than the media perimeter pₘ. In some examples, the print unit 12 may be configured to both print the image to be transferred by the image forming blanket 13 onto the media and print the raised support image 26 on the impression media 25. Alternatively, in some examples, the image forming apparatus 100 may include a supplemental print unit 52 (FIG. 5). The supplemental print unit 52 may print the raised support image 26 on the impression media 25 and the print unit 12 may print an image to be transferred by the image forming blanket 13 onto the media 24. For example, the print unit 12 may apply ink to the PIP to form an image. The PIP may transfer the image to the image forming blanket 13. Subsequently, the image forming blanket 13 may transfer the image to the media 24. In some examples, the print unit 13 and/or supplemental print unit 52 may include an inkjet print head, a binary ink developer, and the like. The ink may include material deposited onto a surface by an image forming apparatus including liquid toners, dry toners, UV cured inks, thermally cured inks, inkjet inks, pigment inks, dye based inks, solutions with colorant, solutions without colorant, solvent based inks, water based inks, plastisols, or other appropriate solutions.

Referring to FIGS. 3B and 3C, in some examples, the image forming blanket 13 may transfer the image to a front surface 24b of the media 24 from the image forming blanket 13 by contacting the media 24 and bending the edge portion 24a of the media 24 about the raised support image 26. For example, a portion of a back surface 24c of the media may be supported by the raised support image 26 printed on the impression media 25 such that an edge portion 24a of the media 24 may extend beyond the support perimeter pₛ. In some examples, the edge portion 24a may not be supported by the raised support image 26. For example, space and/or air may be adjacent to the edge portion 24a. In some examples, a portion of the image forming blanket 13 and the edge portion 24a may bend in conformity with each other. The image forming blanket 13 may transfer the image to a front surface 24b of the media 24 from the image forming blanket 13 by contacting the media 24 and bending the edge portion 24a of the media 24 about the raised support image 26. Accordingly, the edge portion 24a of the media 24 may create a curved and/or rounded shape for the transition portion of the image forming blanket 13 to conform to in the image transfer state and, thus, reducing stressing forces thereon. Consequently, the formation of edge marks on the image forming blanket 13 and degradation of the image forming blanket 13 may be reduced.

FIG. 4D is a perspective view illustrating a raised support image and an impression media according to an example. Referring to FIG. 4D, a raised support image 36 formed on the impression media 25 may include a media receiving portion 36a and a border portion 36b to surround the media receiving portion 36a. The border portion 36b may include a thickness rₜ substantially equal to a thickness of the media to be received by the media receiving portion 36a. In some examples, an outer perimeter of the border portion 36b may correspond to an outer perimeter of the impression media.25. Accordingly, in operation, the image forming blanket 13 may transfer an image to the media and remain substantially flat upon contact with the media and border portion due to the border portion 36b having a thickness rₜ substantially equal to the thickness of the media.

FIG. 5 is a schematic diagram illustrating an image forming apparatus such as an LEP apparatus according to an example. Referring to FIG. 5, in some examples, the LEP apparatus may include a print unit 12, a supplemental print unit 52, a photo-imaging cylinder 54, a photo charging unit 51, a blanket cylinder 53 including an image forming blanket 13, and an impression cylinder 55. The image forming apparatus 100 may form an image on media 24. The image may include text, symbols, and/or graphics, and the like. In some examples, the image may be initially formed on the photo-imaging cylinder 54, transferred to the blanket cylinder 53, and then transferred to the media 24. For example, an image may be formed on the photo-imaging cylinder 54 by rotating it under the photo charging unit 51. The photo charging unit 51 may include a charging device such as corona wire, charge roller, or other charging device and a laser imaging portion. A uniform static charge may be deposited on the photo-imaging cylinder 54 by the photo charging unit 51. As the photo-imaging cylinder 54 continues to rotate, it passes the laser imaging portion of the photo charging unit 51 to dissipate the static charges in selected portions of the image area to leave an electrostatic charge pattern corresponding to the image to be printed.

Referring to FIG. 5, in some examples, ink may be transferred onto the photo-imaging cylinder 54 by a print unit 12. In some examples, the print unit 12 may include a plurality of binary ink developers (BIDs) 12a, 12b, 12c, 12d, 12e, 12f, and 12g. In some examples, a respective BID may correspond to each ink color. During printing, the appropriate BID may engage with the photo-imaging cylinder 54. The engaged BID unit may provide a uniform layer of ink to the photo-imaging cylinder 54. For example, the ink may include electrically charged pigment particles attracted to the opposing electrical fields on the image areas of the photo-imaging cylinder 54. Additionally, the ink may be repelled from the uncharged, non-image areas forming a single color ink image on its surface. The photo-imaging cylinder 54 may continue to rotate and transfer the ink image to the image forming blanket 13, for example, surrounding the blanket cylinder 53. The image forming blanket 13 may transfer the image to the media 24 transported into a nip 57 between the blanket cylinder 53 and the impression cylinder 55. The process may be repeated for each of the colored ink layers to be included in the final image.

In some examples, the impression media 25 may be impression paper to receive the raised support image 26. For example, the raised support image 26 may be printed on the impression media 25 by the supplemental print unit 52 as illustrated in FIG. 5. The supplemental print unit 52 may include a BID, inkjet printhead, and the like, to provide ink to the impression media 25 to form the raised support image 26 thereon. Alternatively, the raised support image 26 may be printed on the impression media 25 by the print unit 12. Subsequently, the impression media 25 and the raised support image 26 thereon are disposed below the media 24. That is, the raised support image 26 contacts and supports a back surface 24c of the media 24 and allows an edge portion 24a of the media 24 to be unsupported by the raised support image 26 in an image transfer state. For example, space and/or air may be adjacent to the edge portion 24a.

In the image transfer state, the media 24 and impression media 25 enter the nip 57. In doing so, the image forming blanket 13 contacts the media 25 and transfers the image thereto. That is, the image forming blanket 13 may transfer the image to a front surface 24a of the media 24 from the image forming blanket 13 by contacting the media 24 and bending the edge portion 24a of the media 24 about the raised support image 26. Accordingly, the edge portion 24a of the media 24 may create a curved and/or rounded shape for the transition portion of the image forming blanket 13 to conform to in the image transfer state and, thus, reducing stressing forces thereon. Consequently, the formation of edge marks on the image forming blanket 13 and degradation of the image forming blanket 13 may be reduced. To form a single color image, one pass of the media 24 through the nip 57 may complete the image. For a color image, the media 24 may be retained to make multiple contacts with the blanket cylinder 53 as it passes through the nip 57. The term nip 57, for example, refers to a region between two rollers 53 and 55 where the respective rollers 53 and 55 are in closest proximity to each other. At each contact, an additional color plane may be placed on the media 24. Alternatively, all the color planes may be accumulated on the image forming blanket 13 and then transferred at once to the media 24.

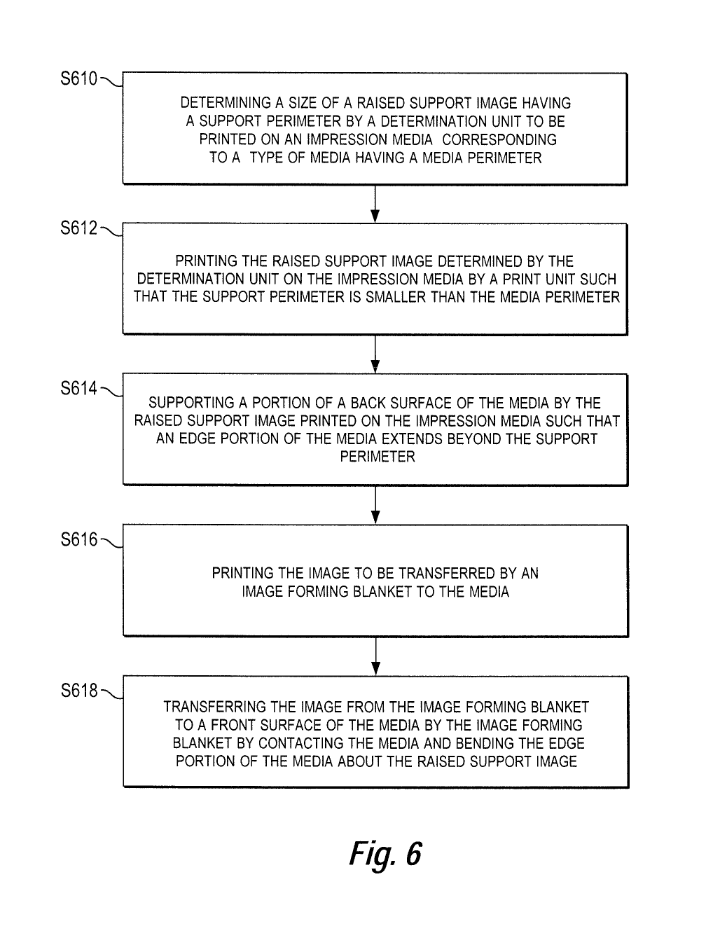

FIG. 6 is a flowchart illustrating a method of transferring an image from an image forming blanket to media according to an example. Referring to FIG. 6, in block S610, a size of a raised support image having a support perimeter is determined by a determination unit to be printed on an impression media corresponding to a type of media having a media perimeter. For example, the size of the raised support image may include at least one of a width, a length, and a thickness. For example, the type of media may include at least one of a size of the media, a thickness of the media, and a shape of the media.

In block S612, the raised support image determined by the determination unit is printed on the impression media by a print unit such that the support perimeter is smaller than the media perimeter. The media perimeter of the media may surround the support perimeter of the raised support image when the raised support image is in contact with the back surface of the media. In some examples, the media perimeter and the support perimeter may be rectangular. Additionally, printing the raised support image may include printing a multilayer image having an edge profile extending outward from the impression media. The edge profile may include at least one of a vertical edge substantially perpendicular to the impression media, a slanted edge, and a rounded edge. For example, the printing the image to be transferred by an image forming blanket to the media may be performed by the print unit. Alternatively, the printing the image to be transferred by an image forming blanket to the media may be performed by a supplemental print unit.

In block S614, a portion of a back surface of the media is supported by the raised support image printed on the impression media such that an edge portion of the media extends beyond the support perimeter. In block S616, the image to be transferred by an image forming blanket to the media is printed by the print unit. For example, the print unit may apply ink to the PIP to form an image. The PIP may transfer the image to the image forming blanket. Subsequently, in block S618, the image forming blanket may transfer the image to the media. That is, in block S618, the image from the image forming blanket is transferred to a front surface of the media by the image forming blanket contacting the media and bending the edge portion of the media about the raised support image. In some examples, the transferring the image from the image forming blanket to a front surface of the media by the image forming blanket may include bending a portion of the image forming blanket and the edge portion of the media in conformity with each other.

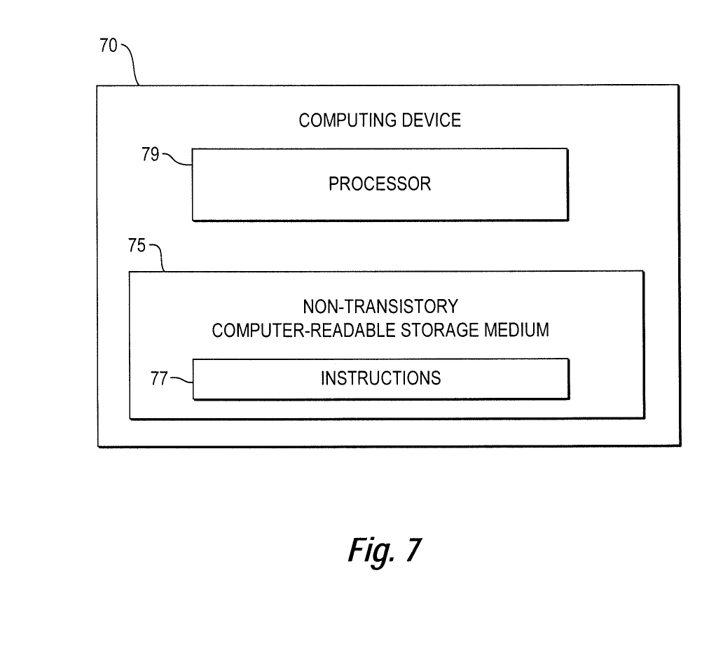

FIG. 7 is a block diagram illustrating a computing device such as an image forming apparatus including a processor and a non-transitory, computer-readable storage medium to store instructions to operate the computing device to transfer an image from an image forming blanket to media according to an example. Referring to FIG. 7, in some examples, the non-transitory, computer-readable storage medium 77 may be included in a computing device 70 such as an image forming apparatus 100. In some examples, the non-transitory, computer-readable storage medium 77 may be implemented in whole or in part as computer-implemented instructions stored in the image forming apparatus 100 locally or remotely, for example, in a server or a host computing device considered herein to be part of the image forming apparatus 100.

Referring to FIG. 7, in some examples, the non-transitory, computer-readable storage medium 75 may correspond to a storage device that stores instructions 77 such as computer-implemented instructions, programming code, and the like. For example, the non-transitory, computer-readable storage medium 75 may include a non-volatile memory, a volatile memory, and/or a storage device. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM).

Referring to FIG. 7, examples of storage devices include, but are not limited to, hard disk drives, compact disc drives, digital versatile disc drives, optical drives, and flash memory devices. In some examples, the non-transitory, computer-readable storage medium 75 may even be paper or another suitable medium upon which the instructions 77 are printed, as the instructions 77 can be electronically captured, via, for instance, optical scanning of the paper or other medium, then compiled, interpreted or otherwise processed in a single manner, if necessary, and then stored therein. A processor 79 generally retrieves and executes the instructions 77 stored in the non-transitory, computer-readable storage medium 75, for example, to operate a computing device 70 such as an image forming apparatus 100 to transfer an image from an image forming blanket 13 (FIG. 1) to media 24 in accordance with an example. In an example, the non-transitory, computer-readable storage medium 75 may be accessed by the processor 79.

It is to be understood that the flowchart of FIG. 6 illustrates architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 6 illustrates a specific order of execution, the order of execution may differ from that which is depicted. For example, the order of execution of two or more blocks may be scrambled relative to the order illustrated. Also, two or more blocks illustrated in succession in FIG. 6 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. An image forming apparatus, comprising
a determination unit to determine a type of a raised support image having a support perimeter to be printed on an impression media corresponding to a type of media;
a print unit to at least one of print the image to be transferred by the image forming blanket to the media and print the raised support image determined by the determination unit on the impression media such that the support perimeter is smaller than the media perimeter; and
an image forming blanket to transfer the image to a front surface of the media from the image forming blanket by contacting the media and bending the edge portion of the media about the raised support image.

2. The image forming apparatus according to claim 1, wherein the type of a raised support image comprises a size of the raised support image.

3. The image forming apparatus according to claim 1, further comprising:
a supplemental print unit to print the raised support image determined by the determination unit on the impression media such that the support perimeter is smaller than the media perimeter; and
wherein the print unit is configured to print the image to be transferred by the image forming blanket to the media.

4. The image forming apparatus according to claim 1, wherein a portion of a back surface of the media is supported by the raised support image printed on the impression media such that an edge portion of the media extends beyond the support perimeter.

5. A method of transferring an image from an image forming blanket to media, the method comprising:
determining a size of a raised support image having a support perimeter by a determination unit to be printed on an impression media corresponding to a type of media having a media perimeter;
printing the raised support image determined by the determination unit on the impression media by a print unit such that the support perimeter is smaller than the media perimeter;
supporting a portion of a back surface of the media by the raised support image printed on the impression media such that an edge portion of the media extends beyond the support perimeter;
printing the image to be transferred by an image forming blanket to the media; and
transferring the image from the image forming blanket to a front surface of the media by the image forming blanket contacting the media and bending the edge portion of the media about the raised support image.

6. The method according to claim 5, wherein the type of media comprises at least one of a size of the media, a thickness of the media, and a shape of the media.

7. The method according to claim 5, wherein the determining a size of a raised support image having a support perimeter by a determination unit further comprises:
determining at least one of a width, a length and a thickness of the raised support image.

8. The method according to claim 7, wherein the media perimeter and the support perimeter are rectangular.

9. The method according to claim 5, wherein the printing the raised support image determined by the determination unit on the impression media by the print unit further comprises:
printing a multilayer image having an edge profile extending outward from the impression media.

10. The method according to claim 9, wherein the edge profile comprises at least one of a vertical edge substantially perpendicular to the impression media, a slanted edge, and a rounded edge.

11. The method according to claim 5, wherein the media perimeter of the media surrounds the support perimeter of the raised support image when the raised support image is in contact with the back surface of the media.

12. The method according to claim 5, wherein the printing the image to be transferred by the image forming blanket to the media is performed by the print unit.

13. The method according to claim 5, wherein the printing the image to be transferred by the image forming blanket to the media is performed by a supplemental print unit.

14. The method according to claim 5, wherein the transferring the image from the image forming blanket to a front surface of the media by the image forming blanket further comprises:
bending a portion of the image forming blanket and the edge portion of the media in conformity with each other.

15. A non-transitory computer-readable storage medium having computer executable instructions stored thereon for an image forming apparatus to transfer an image from an image forming blanket to media, the instructions are executable by a processor to:
determine a raised support image having a support perimeter by a determination unit to be printed on an impression media corresponding to a type of media;
print the raised support image determined by the determination unit on the impression media by a print unit;
support a portion of a back surface of the media by the raised support image printed on the impression media;
print the image to be transferred by the image forming blanket to the media by at least one of the print unit and a supplemental print unit; and
transfer the image from the image forming blanket to a front surface of the media by the image forming blanket contacting the media.
